(19) United States
(12) Patent Application Publication
(10) Pub. No.: US 2023/0376741 A1
(43) Pub. Date: Nov. 23, 2023

(54) OPTOELECTRONIC COMPUTING SYSTEMS AND FOLDED 4F CONVOLUTION LENSES

(71) Applicant: Neurophos LLC, Durham, NC (US)

(72) Inventors: Patrick T. Bowen, Austin, TX (US); Andrew J. Traverso, Durham, NC (US); Daniel Marks, Durham, NC (US); Tom Driscoll, San Diego, CA (US); David Smith, Durham, NC (US)

(21) Appl. No.: 18/362,301

(22) Filed: Jul. 31, 2023

Related U.S. Application Data
(63) Continuation of application No. PCT/US2022/015159, filed on Feb. 3, 2022.
(60) Provisional application No. 63/145,350, filed on Feb. 3, 2021.
(60) Provisional application No. 63/160,276, filed on Mar. 12, 2021.
(60) Provisional application No. 63/162,392, filed on Mar. 17, 2021.

(51) Int. Cl. G06N 3/067; G02B 1/00; G02B 13/18; G02B 1/02; G02B 27/46; G06N 3/0464

(52) U.S. Cl. CPC G06N 3/0675; G02B 1/002; G02B 13/18; G02B 1/02; G02B 27/46; G06N 3/0464

(57) ABSTRACT

According to various embodiments, an optoelectronic computer architecture is described herein for use as a convolutional neural network. The optoelectronic computer architecture includes a four-focal length (4F) optical subsystem that utilizes metasurfaces and lenses in conjunction with a digital electronic subsystem. Digital-to-analog converters and analog-to-digital converters are used to interface the optical subsystem and the digital subsystem. Various 4F lens and metasurface configurations are described herein, including various folded 4F lens configurations.

### RELATED APPLICATIONS

This application is continuation of PCT Application No. PCT/US2022/015159 filed on Feb. 3, 2022 titled “Optoelectronic Computing Systems and Folded 4F Convolution Lenses,” which application claims benefit of and priority to U.S. Provisional Patent Application No. 63/145,350 titled “Opto-Electronic Accelerator for Convolutional Neural Networks Using Metamaterials” filed on Feb. 3, 2021, and claims benefit and priority to U.S. Provisional Patent Application No. 63/160,276 titled “Folded 4-F Convolution Lenses” filed on Mar. 12, 2021, and claims benefit and priority to U.S. Provisional Patent Application No. 63/162,392 titled “Folded 4-F Convolution Lens System with Dual Spatial Light Modulators” filed Mar. 17, 2021, which applications are hereby incorporated by reference in their entireties.

### TECHNICAL FIELD

This application generally relates to metamaterial elements, machine learning, artificial intelligence, and convolutional neural networks. Various embodiments of this application are more specifically related to convolution lenses, the mathematical operations of convolution and Fourier transform, and optical computing architectures.

### BRIEF DESCRIPTION OF THE DRAWINGS

FIG. 1 illustrates a block diagram of a convolutional neural network, according to one embodiment.

FIG. 2A illustrates a block diagram of an optoelectronic computer for accelerated computation of convolutional neural networks, according to one embodiment.

FIG. 2B illustrates an example rendering of an optoelectronic computing system, according to one embodiment.

FIG. 3 illustrates a table of scaling metrics in computing convolutional neural networks, according to one embodiment.

FIG. 4 illustrates an example of a four-focal length (4F) lens system, according to one embodiment.

FIG. 5 illustrates an example of a folded 4F system, according to one embodiment.

FIG. 6 illustrates a block diagram of an example computation cycle in a folded 4F system convolutional neural network, according to one embodiment.

FIG. 7A illustrates an example layout of a folded 4F lens, according to one embodiment.

FIG. 7B illustrates a graph of root-mean-square (RMS) wavefront error with respect to a field of the 4F lens layout of FIG. 7A, according to one embodiment.

FIG. 7C illustrates a spot diagram of various field points of the 4F lens layout of FIG. 7A, according to one embodiment.

FIG. 8A illustrates an example layout of a folded 4F ZnSe lens, according to one embodiment.

FIG. 8B illustrates a graph of RMS wavefront error with respect to a field of the 4F ZnSe lens layout of FIG. 8A, according to one embodiment.

FIG. 8C illustrates a spot diagram of various field points of the 4F ZnSe lens layout of FIG. 8A, according to one embodiment.

FIG. 9A illustrates an example layout of a folded 4F silicon lens, according to one embodiment.

FIG. 9B illustrates a graph of RMS wavefront error with respect to a field of the 4F silicon lens layout of FIG. 9A, according to one embodiment.

FIG. 9C illustrates a spot diagram of various field points of the 4F silicon lens layout of FIG. 9A, according to one embodiment.

FIG. 10 illustrates a block diagram of an example optoelectronic convolution system, according to one embodiment.

FIG. 11A illustrates a block diagram of a Fourier transform encoding stage of a convolution function via an optical convolution system with dual spatial light modulators (SLMs), according to one embodiment.

FIG. 11B illustrates a block diagram of a kernel function encoding stage of a convolution function via the dual-SLM optical convolution system, according to one embodiment.

FIG. 11C illustrates a block diagram of an electronic computation and relay stage of a convolution function via the dual-SLM optical convolution system, according to one embodiment.

FIG. 12 illustrates multiple convolution operations performed simultaneously and added together using a single optical convolution, according to one embodiment.

### DETAILED DESCRIPTION

Various examples of the systems and methods described herein relate to optical computer architectures to compute convolutional neural networks at increased speeds and reduced power consumption compared to digital computers. According to various embodiments, the proposed optical computer architecture utilizes dynamic metasurfaces to encode digital information in the optical domain and computes convolutions using a four-focal length (4F) optical system.

According to various embodiments, convolutional neural networks can be understood as a standard set of algorithms used for voice recognition, object detection, classification and tracking, image segmentation, and more general image processing operations. While extremely useful, these algorithms are computationally costly when implemented on digital electronic hardware, to the point where the computational power and latency costs make them difficult or even impossible to implement for many applications

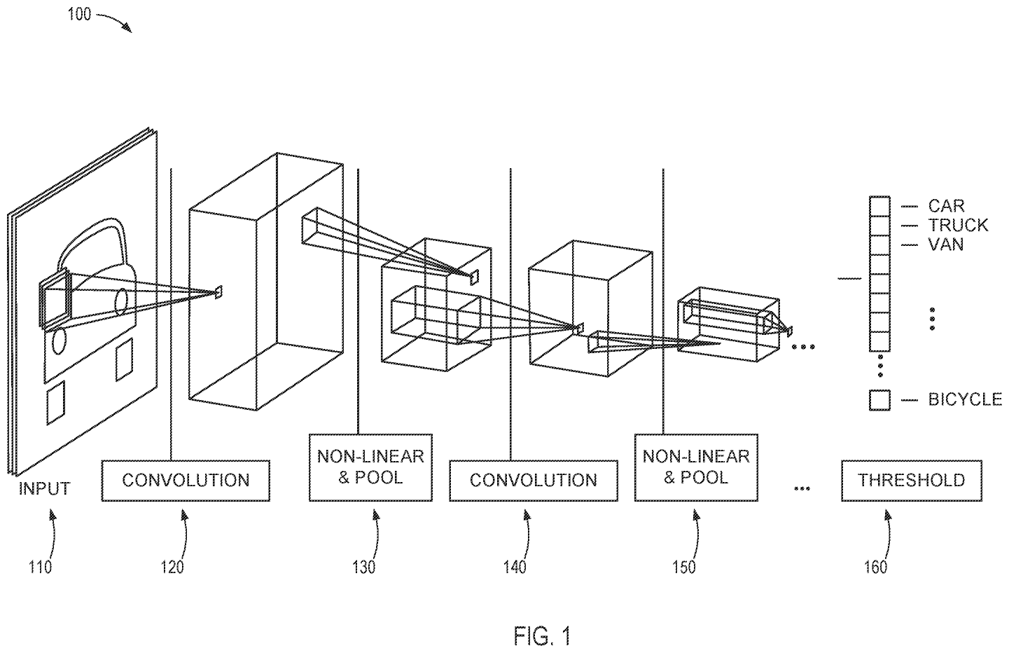

FIG. 1 illustrates a block diagram of a convolutional neural network 100, according to one embodiment. The convolutional neural network 100 may, for example, receive an image as an input 110 and perform sequential convolution 120 and 140 and nonlinear activation and MaxPooling operations 130 and 150. The convolutional neural network 100 may include any number of convolution stages and any number of computational operations before threshold comparisons 160 are used to, in the illustrated example, identify one or more objects in the image input 110.

In many embodiments, most of the computational cost of implementing a neural network is associated with computing the convolution operations (e.g., 120 and 140 in the illustrated example). Other operations, such as threshold comparisons, nonlinear activation and MaxPooling, can be performed relatively quickly and with minimal computational cost compared to calculating the convolution operations.

The presently described systems and methods propose an optical computing approach for convolution operations to increase the speed and reduce the power consumption associated with the convolution operations of a convolutional neural network 100. In various embodiments the optical computing components for implementing the convolutional operations may be integrated within a digital computing system that performs other computation operations using digital computing techniques (e.g., via application-specific integrated circuits (ASICs) or microprocessors). Such a system may be referred to as an optoelectronic system that implements the convolutions optically and the nonlinear activations and MaxPool operations electronically.

Existing optoelectronic systems utilize relatively high optical powers that render them infeasible or inferior to digital electronic approaches with respect to power consumption. For example, existing optical 4F system architectures, such as those used to reconstruct synthetic aperture radar images before digital computers, have proved impractical for convolutional neural networks due to the lack of fast and efficient spatial light modulators. Various embodiments of the presently described systems and methods propose the use of dynamically tunable metasurfaces instead of spatial light modulators. Dynamically tunable metasurfaces can be implemented with three orders of magnitude higher switching speed, smaller pixel sizes, at a lower cost, and with a lower switching power consumption compared to traditional spatial light modulators.

The presently described systems and methods include various embodiments of optoelectronic computing systems, optoelectronic convolutional neural network (CNN) computing systems, and other systems to perform convolution operations in the optical domain using optical fields. Additionally, some specific optical systems and lens element layouts are described for performing optical convolutions of optical fields. In one example, an optoelectronic computing system includes an electronic subsystem, spatial light modulators, an optical subsystem to perform an optical convolution, an optical detection system, and a digital processing system.

In various embodiments, the optoelectronic computing system includes an electronic subsystem to receive input digital data and a first spatial light modulator to transmit a coherent optical field encoded with the input digital data. An optical subsystem may include on or more lenses and/or additional spatial light modulators to implement a first Fourier transform of the coherent optical field encoded with the input digital data. The transformed optical field can then be modulated with kernel data, such that the kernel data is modulated onto the coherent optical field, along with the encoded input digital data. The optical subsystem may then implement a second Fourier transform of the coherent optical field to generate an output optical field that is encoded with a convolution of the input digital data and the kernel data. The optoelectronic computing system may further include an optical detection subsystem to convert the output optical field to an output digital signal. The output digital signal represents the convolution of the input digital signal with the kernel data, as optically computed by the optical subsystem. In various embodiments, the optoelectronic computing system may further include a digital processing subsystem to perform at least one mathematical operation on the output digital signal.

In various embodiments described herein, the spatial light modulators may be embodied as tunable optical metasurfaces, digital micromirror devices, and/or liquid crystal on silicon devices. In some embodiments, such as in the folded 4F systems described below, reflective metasurfaces, digital micromirror devices, liquid crystal on silicon devices, and/or other spatial light modulators may be utilized. As described herein, various lenses, lens layouts, mirrors, and other optical elements may be combined to form the optical subsystem that implements the operations described herein. Specific examples of suitable lens configurations are described herein, but it is appreciated that alternative configurations may be used.

The presently described systems and methods may also be used to form an optoelectronic convolutional neural network (CNN) computing system. A CNN computing system may include, for example, tunable optical metasurfaces for encoding input data into the optical domain and then modulating kernel data onto the light field. The optical subsystem (e.g., a folded 4F optical subsystem) may compute a convolution of the input data and the kernel data in the optical domain. A detector subsystem can then convert the computed convolution in the optical domain into a digital signal for subsequent processing by a digital electronic subsystem.

In some embodiments, the optical system described herein for performing convolution operations in the optical domain may be used for any of a wide variety of alternative purposes and is not limited to usage in conjunction with CNN computing systems. Various systems are described herein to perform convolution operations in the optical domain (e.g., using modulated light or optical fields that are passed through lenses configured to implement Fourier transformations). The convolution operation may include, for example, encoding (e.g., via a first modulator) input data to be convolved onto an object field. The systems compute (e.g., via a first Fourier transform lens assembly) a first Fourier transform of the object field. A second modulator is used to apply a kernel modulation to the optical field and then a second Fourier transform of the modulated field is computed using the same Fourier transform lens assembly (in a folded 4F optical assembly) or a different Fourier transform lens assembly (in a non-folded 4F optical assembly). The resulting convolution light field represents the convolution of the input data and kernel data. A detector may then be used to generate a digital version of the convolution data for digital processing by digital electronic components or computing systems.

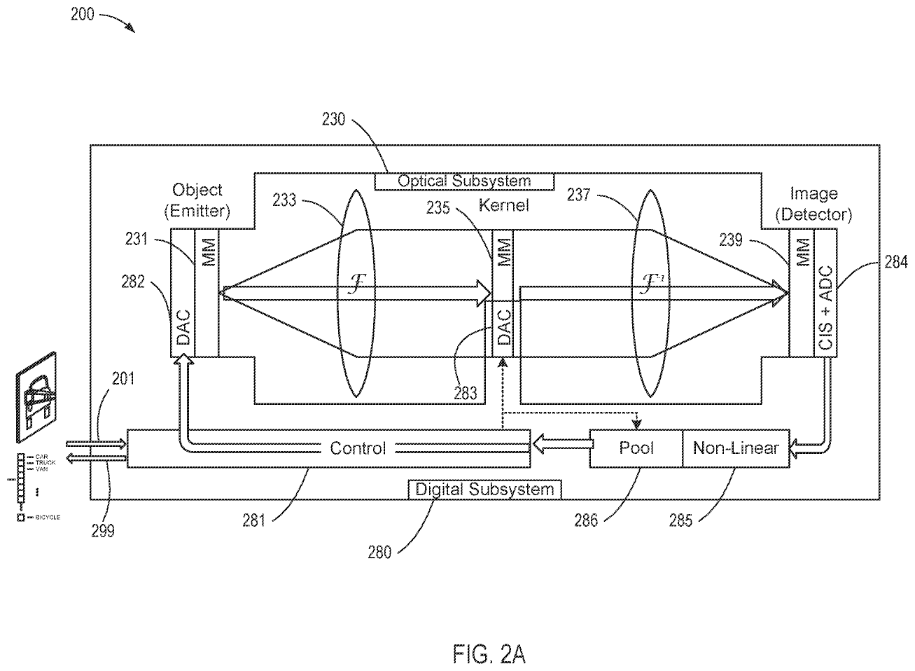

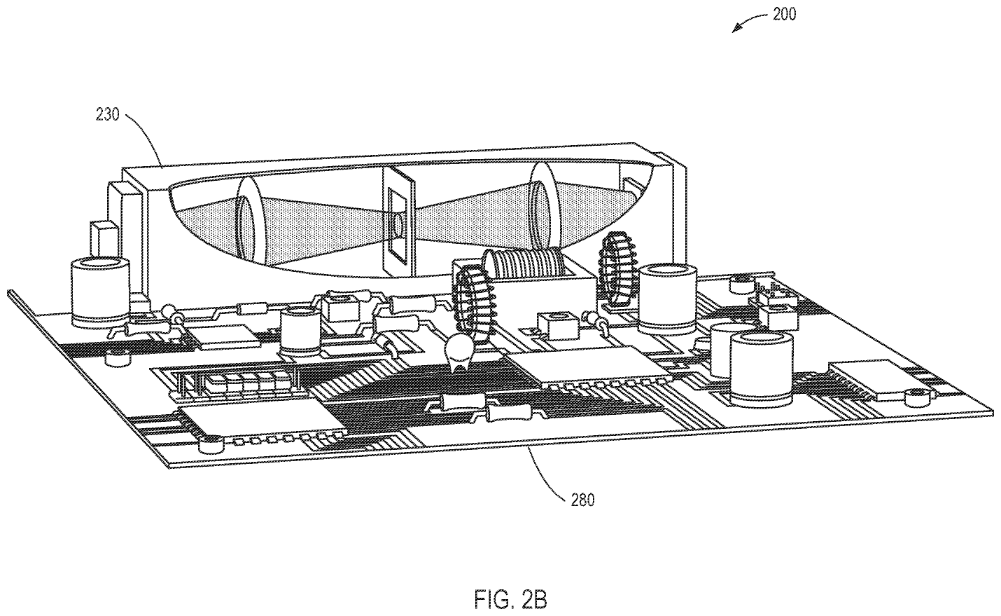

FIG. 2A illustrates a block diagram of an optoelectronic computing system 200 for accelerated computation of convolutional neural networks, according to one embodiment. As illustrated, an input image 201 (or other data) is received by a controller 281 that is part of the digital subsystem 280 (e.g., implemented via digital electronics). The image 201 (or other data) is converted via a digital-to-analog converter (DAC) 282 and an optical object is emitted by a metasurface 231 that is part of a modified 4F optical subsystem 230. A first lens 233 of the optical subsystem implements a Fourier transform of the image 201. The controller 281 uses a DAC 283 and dynamically tunes a metasurface 235 to scatter the Fourier transform of a desired kernel (e.g., using active matrix addressing) in the Fourier plane of the modified 4F optical subsystem 230.

A second lens 237 implements a second Fourier transform to deliver the inversion of the convolution of the image 201 with the kernel to a detector array (e.g., a metasurface detector array 239, as illustrated). A sensor array (e.g., an array of contact image sensors (CISs) and complementary analog-to-digital converters (ADCs)) may be used to convert the convolution for digital processing (e.g., rectified linear unit operation (ReLU), digital nonlinear activation 285, pooling 286, and the like). The result of the process may be stored in a memory (not shown).

The illustrated optoelectronic computing system 200 architecture represents one layer of the neural network. The metasurfaces 231, 235 can be dynamically tuned and the optical subsystem 230 and digital subsystem 280 can be used again for each additional layer of a multilayer convolutional neural network. The illustrated example might be modeled using a field-programmable gate array, programmable logic array, or an ASIC. An ASIC might be particularly useful in some embodiments to reduce power consumption and/or increase digital computations. The optical subsystem 230 may be implemented in an in-reflection architecture to reduce space and eliminate or reduce communication overhead between separate chips.

The optoelectronic computing system 200 may perform a linear operation on an input vector of size N, which is presented as a two-dimensional \sqrt{N}×\sqrt{N} image. Data is represented on a two-dimensional surface on the object plane of the metasurface 231, and computation happens while the light propagates in the third dimension. The lenses 233 and 237 and the metasurface 235 scattering the kernel for convolution operate to implement the convolution computations optically.

In an alternative embodiment, a volumetric metamaterial may be used to implement a (tunable) discrete linear operator of a given size. However, the tuning volumetric metamaterial requires modulating O(N^{3/2}) elements and may not be as computationally cost effective as the illustrated optoelectronic computing system 200, or even digital computing. The illustrated optoelectronic computing system 200 can implement convolutions (the specific subset of linear operators used in convolutional neural networks) by tuning O(N) metamaterial elements. This is because all operators in the convolution class of linear operators share a common space of eigenvectors, which happen to be the basis of plane waves. Accordingly, any convolution operator A can be decomposed as the product of three linear operators, such that:

Ĥ=U^{†}DU Equation 1

In Equation 1, U is a unitary operator defined by the eigen basis of Ĥ which is a Fourier transform. D is a diagonal matrix with the entries being the eigenvalues of Ĥ, and for a convolution operator these entries are the Fourier transform of the kernel. Accordingly, the optoelectronic computing system 200 can implement any convolution operator by changing the diagonal elements of D to implement a different kernel, which is the same number of entries as the input vector to the system. Therefore, only O(N) elements need to be modulated to span the space of convolution operations, significantly reducing the time, energy, and data bandwidth required to change between convolution operators.

In a practical optical system, each of the components U^{†}, D, and U of the decomposition of the convolution operator can be modeled as three separate optical components aligned in series along the optical path, with only D being a dynamically reconfigurable component, and the others being static. The lenses 233 and 237 can implement Fourier transforms of the U^{†} and U operators. The metasurface 235 may implement D as a pixelated scattering surface that can be controlled in both the amplitude and phase of its transmission (or reflection) for each pixel. The metasurface 235 can be implemented with microsecond switching speeds and sub-micron resolution, while still delivering complete amplitude and phase control.

The optical subsystem 230 implements the convolution using coherent light, such as a laser, which is sent into a feed structure (e.g., a waveguide or backplane feed structure) that spreads the incident beam across the surface of the metasurface 235. The metasurface 235 contains a set of optical scattering elements (e.g., tunable optical metamaterial scattering elements with sub-wavelength interelement spacings). The optical scattering elements can be tuned (e.g., voltage controlled) in both amplitude and phase. According to various embodiments, the metasurface may comprise a two-dimensional array of the optical scattering elements arranged with sub-wavelength interelement spacings on a transmissive or reflective surface. Depending on the desired resolution, the two-dimensional array of optical scattering elements may be between, for example, 1 megapixel and 30 megapixels.

According to some embodiments, an input vector, or input image 201, is used as the control signal of the tug mechanism of the scattering elements on the two-dimensional surface, such that each scattering element's polarizability or tuning state is adjusted to take a complex value of a particular component of the input vector, and the scattering from these elements forms an image that traverses the modified 4F optical subsystem 230, as discussed above.

FIG. 2B illustrates an example rendering of an optoelectronic computing system 200, according to one embodiment. The optoelectronic computing system 200 utilizes an in-transmission architecture to integrate the optical subsystem 230 with the digital subsystem 280 implemented as an ASIC. According to some embodiments, the optoelectronic computing system 200 can be implemented within a 5 cm by 5 cm by 10 cm volume.

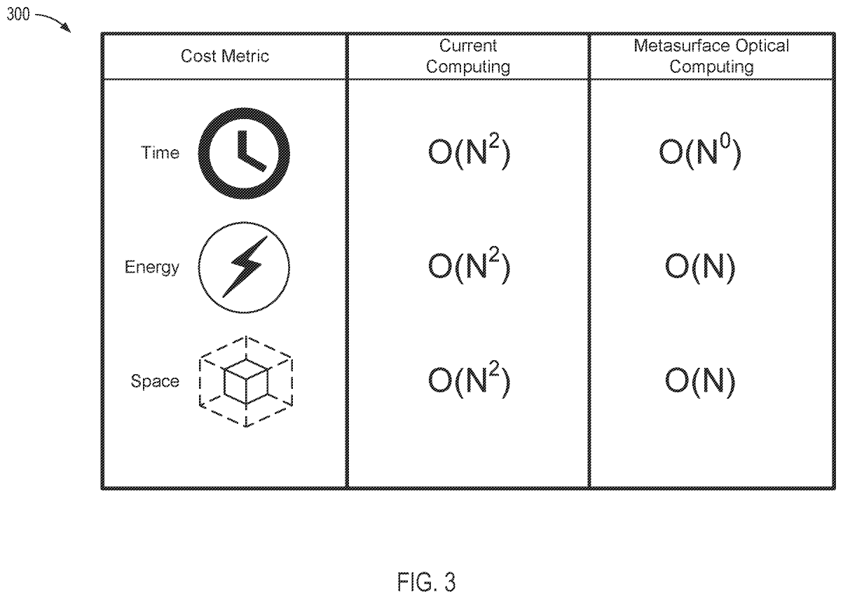

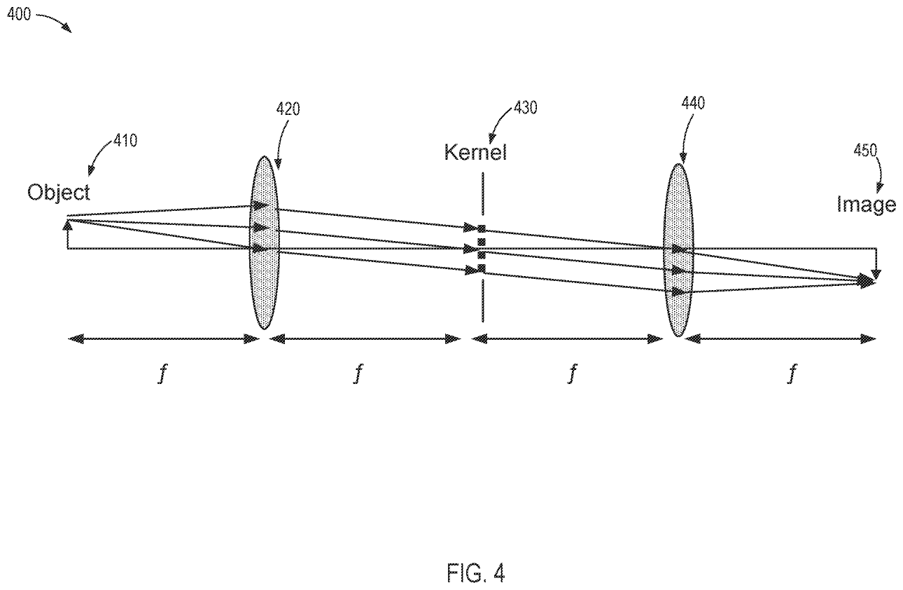

FIG. 3 illustrates a table 300 of scaling metrics in computing convolutional neural networks, according to one embodiment. The operational cost of a convolutional neural network can be measured and compared with other convolutional neural networks in terms of the amount of time operations take to perform, the amount of energy consumed to implement operations, and the physical size of the computing components used to manufacture the system. With very large input vectors N, (e.g., the number of pixels in an image, frames in a video stream, or audio bits), the computations can be relatively onerous for traditional computing systems. As illustrated in FIG. 4, for a given input vector of size, N, the metasurface optical computing approach described herein (e.g., the optical subsystem 230) is faster, consumes less energy, and is physically smaller that an equivalent digital computing system.

In terms of time, computation of a convolution with a digital computing system is an O(NM) operation, where N is the input vector size and M is the kernel size, which may be up to the image size. While this can be parallelized with a GPU or an ASIC with a multiply and accumulate (MAC) array, the number of parallel pipelines is severely limited by the space on a chip. Looking at realistic, state of the art chips, this is typically limited to on the order of 10,000 MAC units in a custom neural network accelerator ASIC. However, using the metasurface optical computing approach described herein (e.g., the optical subsystem 230), the amount of time required to compute a convolution is based on the time it takes a wave phenomenon to propagate through the system, which is independent of both the input vector and kernel vector size, i.e., O(N⁰).

Accordingly, the presently described systems and methods represent a massive increase in computational speed for any convolution-dominated algorithm, resulting in improvements in both latency and throughput for convolutional neural networks. Moreover, when data is represented in two dimensions on the surface of an optical metasurface, as described herein, the size of the input vectors (i.e., images) can be on the order of 10⁷.

The architectures described above utilize analog optical systems for computing convolutions. The precision of a digital computing system is determined by the number of bits of precision used for computations. In contrast, analog computers represent numbers as continuous physical quantities. Therefore, errors can be introduced into the computation by any aberrations or manufacturing errors that deviate the operation of the system from the intended operation. Unlike many computational tasks, many neural networks can tolerate a limited amount of error in their implementation since the learning mechanism of the network offers an ability to self-correct.

The presently described systems and methods utilize an optical subsystem (such as optical subsystem 230) that may be implemented using various configurations of lenses and tunable metasurfaces. In some embodiments, the optical subsystem 230 may be implemented using a reflective spatial light modulator, rather than transmissive spatial light modulators.

FIG. 4 illustrates a 4F lens system 400, according to one embodiment. The illustrated 4F lens system 400 may utilize thin lenses to perform a Fourier transform operation to coherent radiation between two planes that are each a focal length on either side of a first lens 420. As illustrated, the first lens 420 may receive an image of an object 410 and perform a first Fourier transform that is received at the location of the Kernel 430. The convolution may be implemented by two successive stages of Fourier transforms, with the second lens 440 implementing the second Fourier transform. The kernel 430 acts as a “filter” between the two stages and is the Fourier transform of the desired convolution kernel. The 4F lens system 400 provides an output image 450 that is the convolution of the input object 410 and the kernel 430.

The object plane of the input object 410 is a field of coherent radiation in which a signal to be processed is encoded. The object plane may be implemented with an SLM. The source of illumination may be provided by an essentially monochromatic laser which illuminates the object plane by means of an off-axis beam or a fixed hologram, by way of example. As previously described, the first lens 420 performs the first Fourier transform operation of the field from the object 410 to the kernel plane 430 with each placed one focal length away from the first lens 420. At the kernel plane 430, the Fourier transform of the object 410 is modulated by, for example, another SLM. The pattern encoded onto the kernel plane 430 is the Fourier transform of the kernel to be convolved with the object field.

As stated above, the second lens 440 performs a second Fourier transform operation from the field after passing through the kernel plane 430 to the output image plane 450, both of which are also placed one focal length from the second lens 440, so the desired convolution of the object plane 410 is encoded onto the field at the image plane 450. The output image at the image plane 450 may be detected interferometrically, for example, by means of interference with a reference beam which illuminates a detector using an off-axis beam or a fixed hologram. The detector may be, for example, an array detector such as a CMOS (Complementary Metal-Oxide Semiconductor) or CCD (Charge Coupled Device) array of photosensitive pixels. The amplitude and phase of the field may be inferred from the recorded field intensity on the detector, for example, by means of a digital Fourier spatial filter of the intensity pattern, or measuring the interference pattern with several phase shifts between the reference and image fields which are combined to estimate the amplitude and phase.

In the paraxial approximation of the 4F lens system 400, for which the f/# of the system is sufficiently large, and in a small neighborhood of points close to the optical axis, this system performs a nearly ideal, error-free operation. However, this limits the usable field size to only a small fraction of the lens diameter and requires a very long optical system length.

The presently described systems and methods propose alternative 4F optical systems that provide a usable field that is a significant fraction of the optical element diameters and a shorter length. Different 4F optical systems can be characterized and compared with respect to a space-bandwidth product (SBP) that is a dimensionless quantity counting the number of effectively independent points that may be transmitted through the optical system. The SBP is approximately four times the area of the object field, multiplied by the input numerical aperture (NA) squared, divided by the wavelength squared.

The computational capacity of the optical system scales with the SBP, as a Fourier transform lens system with SBP with a count of N, performs a computation roughly analogous to the Fast Fourier Transform (FFT) over a vector of length N. The FFT has an energy cost scaling as N log N and speed scaling with log N while an optical system has a power consumption that scales with N and computes in constant time. Likewise, a conventional digital computing convolution system scales with the product of the size of both functions to be convolved and also therefore scales unfavorably compared to an optical Fourier transform computing system.

Various aberrations are identified as scaling by various exponents of field size and NA. Therefore, as the SBP is increased, particular aberrations of an optical system also increase with the field size and NA. Unlike an ordinary lens that forms an image of a point from an object point, a Fourier transform lens projects a collimated beam or a plane-like wave at a particular angle. Aberrations of the plane-like wave projected as the image of a point are measured in the number of waves of deviation of the wavefront from the ideal plane wave. For a lens to be diffraction-limited, it is required that these aberrations be only a small fraction of a wave, typically less than one-quarter wave. For use in an analog computer, the maximum permissible aberration may be much smaller, such as, for example, one-tenth or even one-hundredth of a wave.

A Fourier-transform lens that can perform larger computations with an increased SBP must be generally held to a low level of aberrations over a wide field and large numerical aperture. Many of the techniques typically used to minimize aberrations may not be employed. For example, many lenses employ selective vignetting of the most aberrated rays to preserve image quality. However, convolution is a space-invariant operation, and vignetting would selectively block rays from certain points and not others, breaking space invariance. Therefore, the lens is designed such that the image is a limiting field stop and the kernel plane is a limiting pupil stop. According to various embodiments, all the lens elements in between the object, image, and kernel planes conduct all rays. Additionally, the lens is telecentric in the object/image space and afocal in the kernel space. Telecentricity ensures that the field captured from each object point is identical. An afocal image space, with the pupil stop at the kernel plane, ensures that the extent of the collimated beam formed by each object point coincides at the kernel plane.

In some embodiments, the optical system may utilize Spatial Light Modulators (SLMs) instead of, or in addition to, metasurfaces, as described herein. In such embodiments, the Fourier lenses interface with the SLMs. An SLM is a device used to modulate a pattern onto an optical wavefront, as a modulation of amplitude, phase, polarization, or a combination of these. A SLM may be used to modulate a field incident on an optical processor as well as within an optical processor, for example, at the object and kernel planes of a 4F optical system. A common application of SLMs is inside display devices, such as liquid crystal display screens and projectors. To fully utilize the SBP of a Fourier transform lens, the number of pixels of the SLM in the field of the lens corresponds to the SBP. In various embodiments, the SBP of the Fourier transform lenses are on the order of 1 million to 100 million. Accordingly, an SLM may need millions of pixels in a small area. To achieve this, SLMs with a very high density of pixels such as digital micromirror devices (DMD) or liquid-crystal on silicon (LCOS) modulators manufactured using microfabrication methods may be utilized.

These SLMs may be reflective rather than transmissive because silicon substrate used therein is opaque. Accordingly, in some embodiments of the presently described systems and methods, an optoelectronic system utilizes a 4F optical arrangement for use with reflective SLMs.

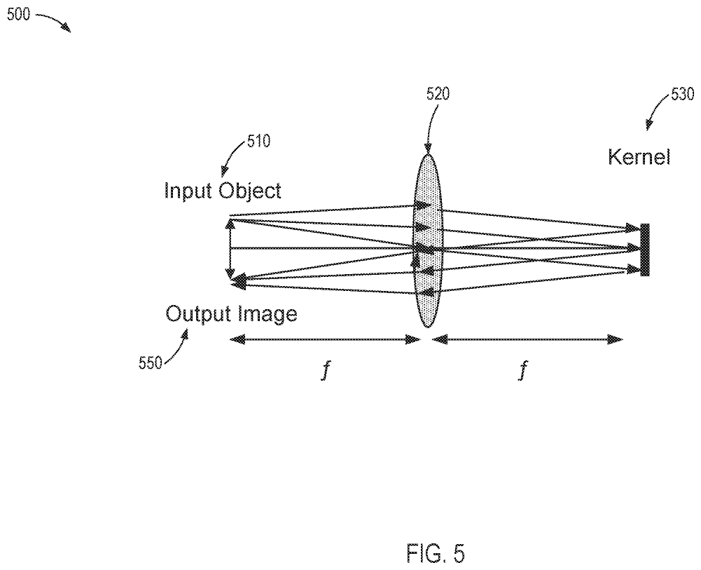

FIG. 5 illustrates an example of a folded 4F system 500, according to one embodiment. As illustrated, the 4F optical arrangement includes a folded optical path in which a signal from an input object 510 is passed through a lens 520 to a kernel 530 (implemented as a reflective SLM), where it is reflected back through the lens 520 to produce an output image 550. The folded 4F optical system 500 is inherently symmetric as it is reflected over the kernel SLM 530, and so the same optics (lens 520) are used in reverse after reflection. Odd-order aberrations such as coma and distortion are inherently cancelled by the symmetric lens system. The length of the folded 4F system 500 is halved, and only half the optical elements (one lens 520) needs to be manufactured. Additionally, the output image 550 is formed next to the object reflected over the optical axis, reducing the delay and energy associated with relaying the data in multilayer neural network implementations.

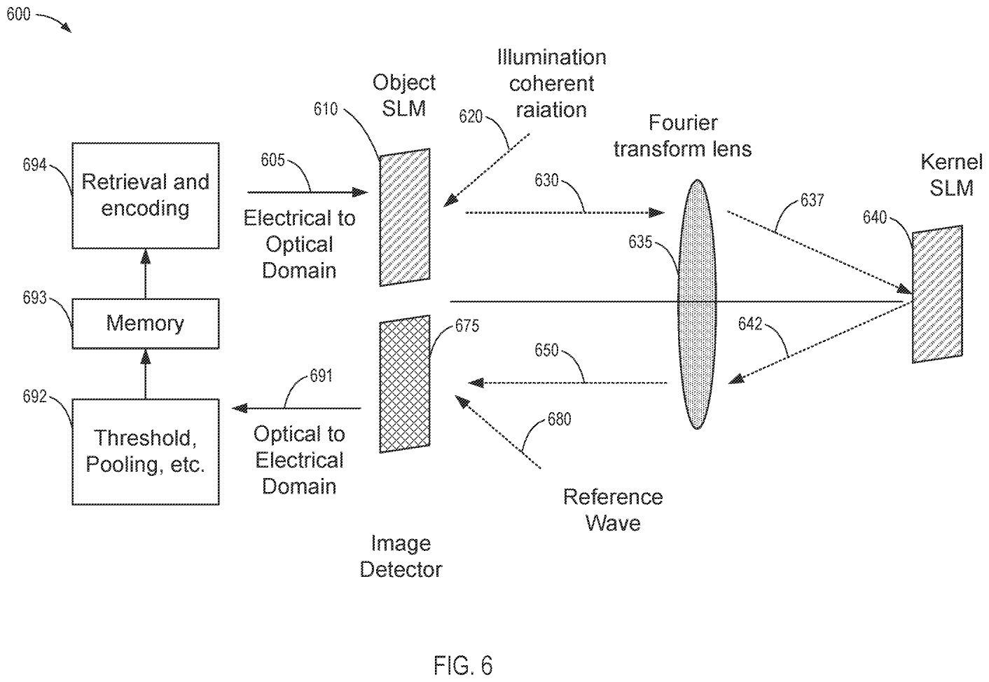

FIG. 6 illustrates a block diagram of an example computation cycle 600 in a folded 4F system convolutional neural network, according to one embodiment. As illustrated, elements of an object SLM 610 are configured and the SLM 610 modulates incoming illumination coherent radiation 620 so that a field encodes the desired data. Encoded data 630 passes through a Fourier transform lens 635 so that the Fourier transform operation occurs to the field. Elements of a kernel SLM 640 are configured to modulate an incoming field 637 so that the desired convolution is performed by the 4-F system. A field 642 reflects backward with its Fourier transform taken again by the lens 635, and a resulting convolution 650 is sampled at an image detector plane 675. The detector plane 675 may be illuminated by a coherent reference wave 680 to facilitate recovery of the phase and amplitude of the image field.

The intensities at the pixels of the detector are converted to electrical samples 691, either analog or digital. As electrical signals, nonlinear computations may be applied to this data, for example, ReLu which is a rectifier, and MaxPool, at 692, which selects the maximum value of a set of samples. The results of these operations may be stored in memory 693 for future retrieval, at 694. The retrieved results, at 694, may be converted to the optical domain, at 605 and utilized for a subsequent convolution by configuring the object plane SLM elements 610 to encode these data onto the optical field.

As discussed above, to increase the speed of the computation, the object SLM 610, image detector 675, and electrical computation including analog to digital (ADC) or digital to analog (DAC) operations, mathematical operations, memory storage, and data transmission (691, 692, 693, 694, and 605) may be integrated into a single electrical package such as a chip carrier with an interposer.

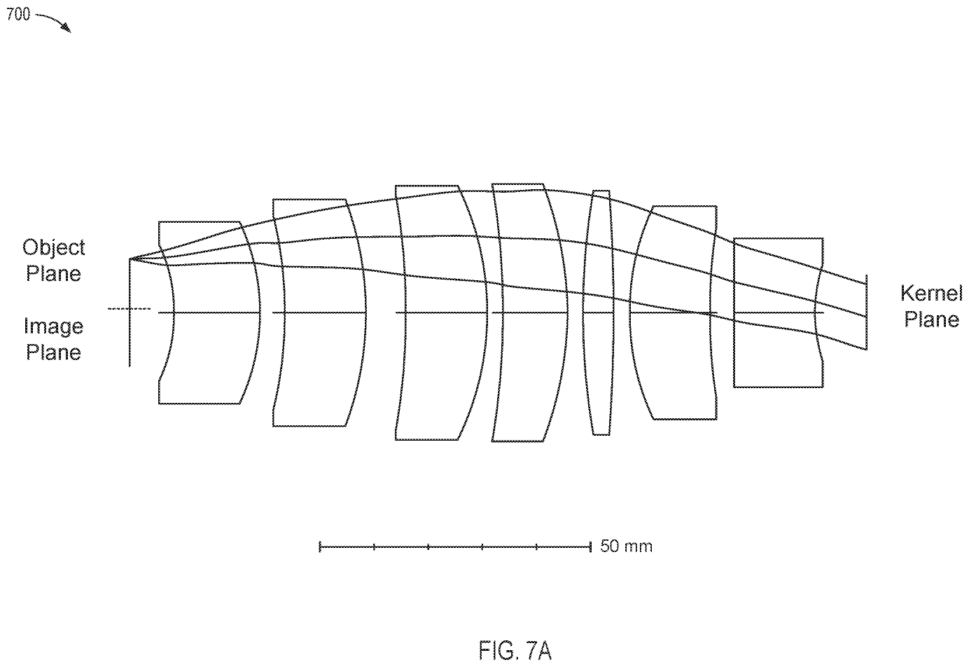

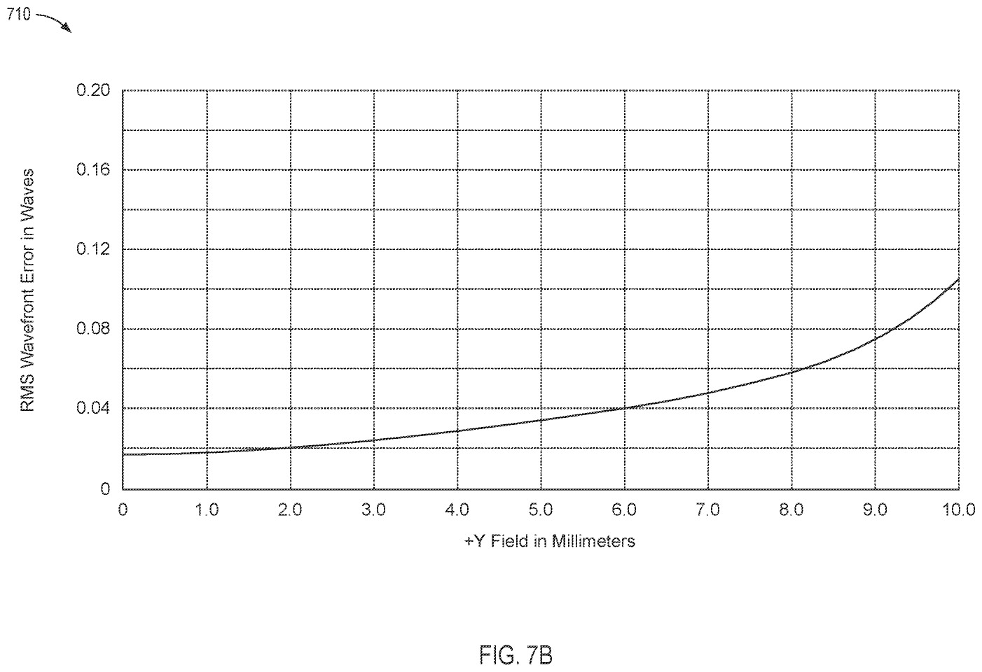

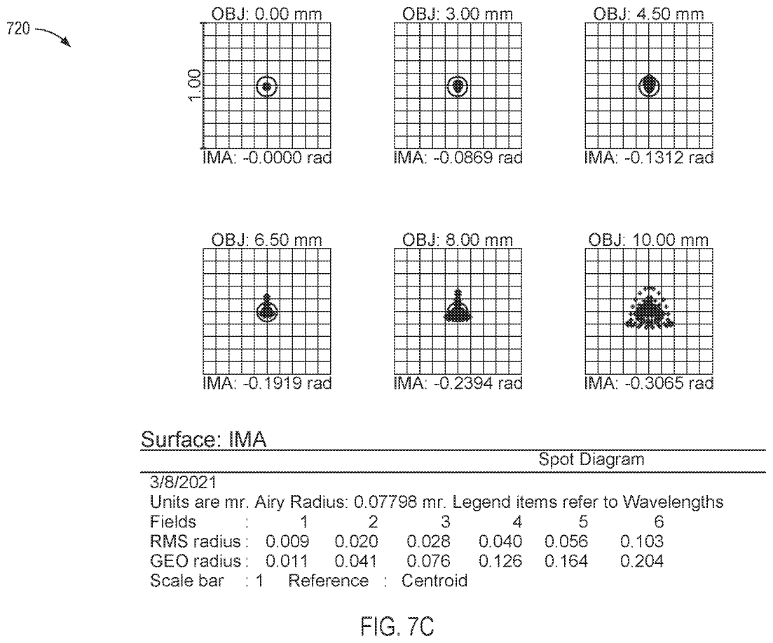

The optical designs described below for folded 4F systems are suitable for use in optoelectronic convolutional neural networks described herein, including those using reflective SLMs. The folded 4F optical systems detailed in FIGS. 7A-9C are telecentric in the object/image plane, afocal in the kernel plane, with the pupil stop coinciding with the kernel plane, do not employ vignetting which would break space invariance, and achieve a useful SBP for optical computation with a CNN with a particular designed root-mean-square (RMS) wavefront error.

FIG. 7A illustrates an example layout 700 of a folded 4F lens, according to one embodiment. The illustrated example folded 4F lens layout 700 operates at, for example, a wavelength of 905 nm, has a NA of 0.2, a circular field size with a radius of 10 mm, and a SBP of 30 million.

The folded 4F lens layout 700 includes seven spherical elements of optical glass with a prescription as follows:
Surfaces: 16
Stop: 15
System Aperture: Object Space NA=0.2
Clear Semi Diameter Margin: Millimeters=1
Fast Semi-Diameters: On
Telecentric Object Space: On
Afocal Image Space: On
Field Unpolarized: On
Convert thin film phase to ray equivalent: On
J/E Conversion Method: X Axis Reference
Glass Catalogs: SCHOTT OHARA
Ray Aiming: Off
Apodization: Uniform, factor=0.00000E+00
Reference OPD: Exit Pupil
Paraxial Rays Setting: Ignore Coordinate Breaks
Method to Compute F/#: Tracing Rays
Method to Compute Huygens Integral: Force Planar
Print Coordinate Breaks: On
Multi-Threading: On
OPD Modulo 2 Pi: Off
Temperature (C): 2.00000E+01
Pressure (ATM): 1.00000E+00
Adjust Index Data To Environment: Off
Effective Focal Length: 34.68132 (in air at system temperature and pressure)
Effective Focal Length: 34.68132 (in image space)
Back Focal Length: 10.094
Total Track: 128.1571
Image Space F/#: 8.495154e-09
Paraxial Working F/#: 10000
Working F/#: 10000
Image Space NA: 3.199801e-05
Object Space NA: 0.2
Stop Radius: 7.079278
Paraxial Image Height: 63792.76
Paraxial Magnification: 6379.276
Entrance Pupil Diameter: 4.082483e+09
Entrance Pupil Position: 1e+10
Exit Pupil Diameter: 14.15859
Exit Pupil Diameter-X: 14.15859
Exit Pupil Diameter-Y: 14.15859
Exit Pupil Position: 0.5228135
Field Type: Object height in Millimeters
Maximum Radial Field: 10
Primary Wavelength [\hat{ }A,tm]: 0.905
Angular Magnification: 2.883397e+08
Lens Units: Millimeters
Source Units: Watts
Analysis Units: Watts/cm\hat{ }2
Afocal Mode Units: milliradians
MTF Units: cycles/millimeter

The surface data summary of the folded 4F lens layout 700 is specified in Table 1 below:

TABLE 1

| | | | | | Clear | Mechanical |
|---|---|---|---|---|---|---|
| Surface | Type | Radius | Thickness | Glass | Diameter | Diameter |
| Obj | STANDARD | Infinity | 8.223738 | | 20 | 20 |
| 1 | STANDARD | −28.5233 | 15.91985 | 1.805181, | 24.4203 | 33.41028 |
| | | | | 25.42536 | | |
| 2 | STANDARD | −40.2876 | 4.607742 | | 33.41028 | 33.41028 |
| 3 | STANDARD | −76.6152 | 15 | 1.805181, | 35.85396 | 41.68056 |
| | | | | 25.42536 | | |
| 4 | STANDARD | −59.9518 | 7.390231 | | 41.68056 | 41.68056 |
| 5 | STANDARD | −131.254 | 15 | 1.487490, | 43.75562 | 46.78476 |
| | | | | 70.23625 | | |
| 6 | STANDARD | −53.0747 | 2.999989 | | 46.78476 | 46.78476 |
| 7 | STANDARD | −132.457 | 11.74133 | 1.487490, | 46.43952 | 47.13632 |
| | | | | 70.23625 | | |
| 8 | STANDARD | −66.4392 | 3.001841 | | 47.13632 | 47.13632 |
| 9 | STANDARD | 131.6447 | 5.652483 | 1.805181, | 44.9807 | 44.9807 |
| | | | | 25.42536 | | |
| 10 | STANDARD | −301.969 | 2.99986 | | 44.08602 | 44.9807 |
| 11 | STANDARD | 46.92711 | 14.87223 | 1.487490, | 39.2029 | 39.2029 |
| | | | | 70.23625 | | |
| 12 | STANDARD | 107.4789 | 4.400295 | | 30.64505 | 39.2029 |
| 13 | STANDARD | −2171.46 | 15.00006 | 1.487490, | 27.38703 | 27.38703 |
| | | | | 70.23625 | | |
| 14 | STANDARD | 29.69587 | 9.571188 | | 18.10052 | 27.38703 |
| STO | STANDARD | Infinity | 0 | | 13.87675 | 13.87675 |
| IMA | STANDARD | Infinity | | | 13.87675 | 13.87675 |

The design tolerances of the folded 4F lens layout 700 can be achieved with typical precision optics manufacturing and passive placement of components in a machined optical barrel. To facilitate manufacturing, the refraction invariant is minimized at each surface. That is, the refraction of rays is divided more equally among the elements rather than a particular surface bending rays sharply. As spherical aberration, coma, and astigmatism are dependent on the refraction invariants of the marginal and chief rays, these aberrations are minimized using this approach. As the radiation is monochromatic, it can be favorable to use higher refractive index glasses as the dispersion these cause is not a concern, and using such glasses allows the curvature of each surface to be minimized as to reduce field curvature.

FIG. 7B illustrates a graph 710 of RMS wavefront error with respect to field of the folded 4F lens layout 700 of FIG. 7A, according to one embodiment. As illustrated, the folded 4F lens layout 700 largely maintains a wavefront error under 1/10 of the wavelength. The main limitation to improved performance is field curvature and astigmatism, which can be seen by the quadratic increase in wavefront error with field position.

FIG. 7C illustrates spot diagram 720 of various field points of the folded 4F lens layout 700 of FIG. 7A, according to one embodiment. The spot diagram 720 shows that the folded 4F lens layout 700 of FIG. 7A has diffraction-limited performance, as indicated by an Airy disc radius up to nearly the edge of the field.

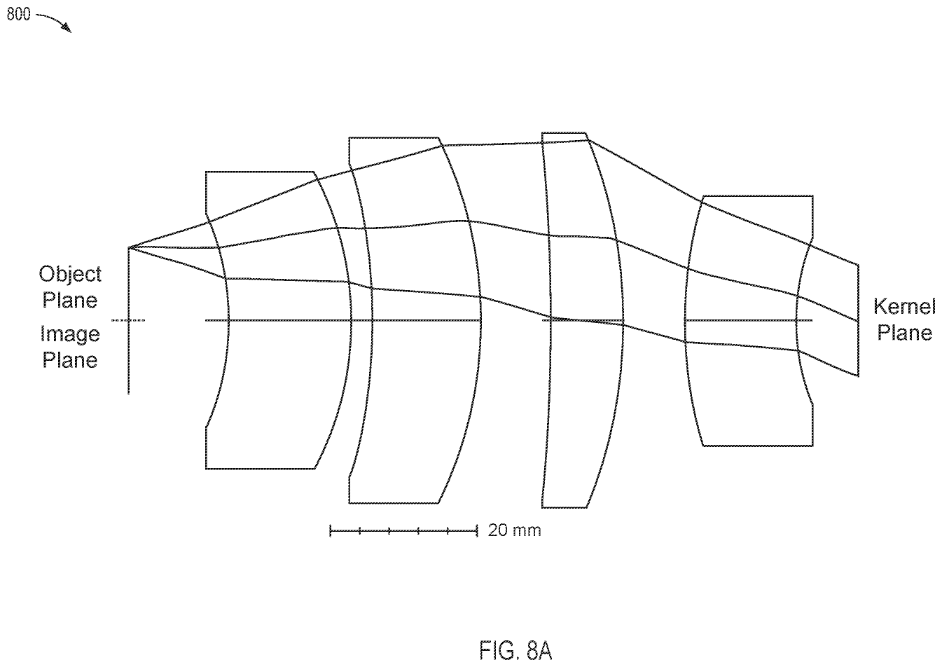

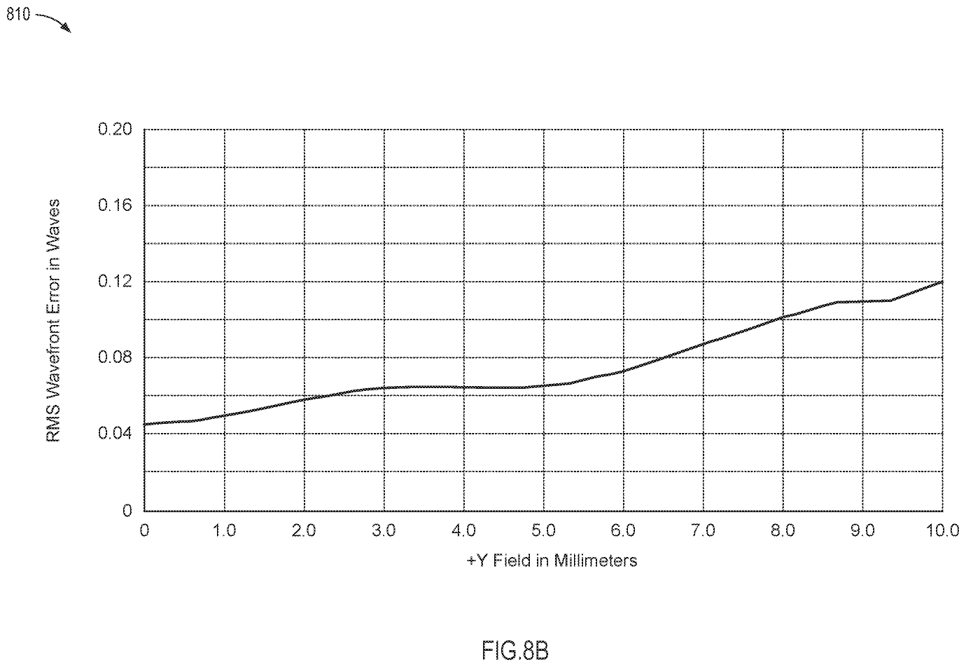

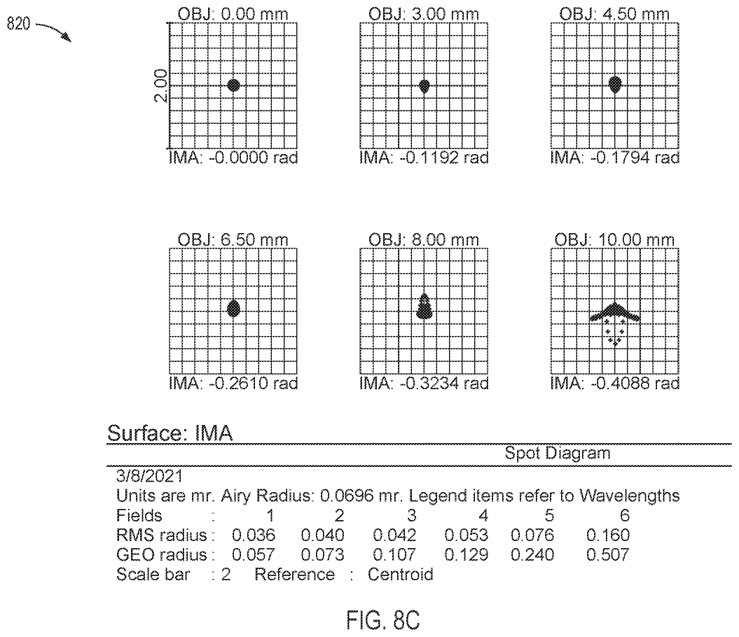

FIG. 8A illustrates an example layout 800 of a folded 4F ZnSe lens, according to one embodiment. The folded 4F ZnSe lens layout 800 utilizes a zinc selenide (ZnSe) material. The higher refractive index of ZnSe allows for a higher numerical aperture to achieved with fewer elements in a more compact design. The folded 4F ZnSe lens layout 800 has an NA of 0.3, a circular field size of radius 10 mm, and operates at a wavelength of 905 nm, to achieve a space bandwidth product of 69 million. This design uses aspheric elements with coefficients of a polynomial determining the surfaces as part of prescription. Because of higher refraction invariants (increased deflection of rays) and steeper curves, tolerances on the folded 4F ZnSe lens layout 800 are significantly tighter than the glass design of FIGS. 7A-7C. The folded 4F ZnSe lens layout 800 is specified as follows:
Surfaces: 10
Stop: 9
System Aperture: Object Space NA=0.3
Clear Semi Diameter Margin: Millimeters=1
Fast Semi-Diameters: On
Telecentric Object Space: On
Afocal Image Space: On
Field Unpolarized: On
Convert thin film phase to ray equivalent: On
J/E Conversion Method: X Axis Reference
Glass Catalogs: SCHOTT OHARA INFRARED
Ray Aiming: Off
Apodization: Uniform, factor=0.00000E+00
Reference OPD: Exit Pupil
Paraxial Rays Setting: Ignore Coordinate Breaks
Method to Compute F/#: Tracing Rays
Method to Compute Huygens Integral: Force Planar
Print Coordinate Breaks: On
Multi-Threading: On
OPD Modulo 2 Pi: Off
Temperature (C): 2.00000E+01
Pressure (ATM): 1.00000E+00
Adjust Index Data To Environment: Off
Effective Focal Length: 25.22037 (in air at system temperature and pressure)
Effective Focal Length: 25.22037 (in image space)
Back Focal Length: 8.8183
Total Track: 86.1842
Image Space F/#: 4.009783e-09
Paraxial Working F/#: 9496.728
Working F/#: 8776.475
Image Space NA: 5.264971e-05
Object Space NA: 0.3
Stop Radius: 7.931424
Paraxial Image Height: 59731.66
Paraxial Magnification: 5973.166
Entrance Pupil Diameter: 6.289709e+09
Entrance Pupil Position: 1e+10
Exit Pupil Diameter: 15.86288
Exit Pupil Diameter-X: 15.86288
Exit Pupil Diameter-Y: 15.86288
Exit Pupil Position: 0.275794
Field Type: Object height in Millimeters
Maximum Radial Field: 10
Primary Wavelength [\hat{ }A,tm]: 0.905
Angular Magnification: 3.96505e+08
Lens Units: Millimeters
Source Units: Watts
Analysis Units: Watts/cm\hat{ }2
Afocal Mode Units: milliradians
MTF Units: cycles/millimeter

The surface data summary of the folded 4F ZnSe lens layout 800 is specified in Table 2 below:

TABLE 2

| | | | | | Clear | Mechanical |
|---|---|---|---|---|---|---|
| Surface | Type | Radius | Thickness | Glass | Diameter | Diameter |
| OBJ | STANDARD | Infinity | 13.74089 | | 20 | 20 |
| 1 | EVENASPH | −42.9136 | 16.78621 | 2.502148, 0.0 | 29.04227 | 40.6618 |
| 2 | STANDARD | −42.4986 | 2.862691 | | 40.6618 | 40.6618 |
| 3 | EVENASPH | −86.6062 | 14.97998 | 2.502148, 0.0 | 42.90925 | 49.89315 |
| 4 | STANDARD | −56.8126 | 9.437868 | | 49.89315 | 49.89315 |
| 5 | STANDARD | −278.029 | 10 | 2.502148, 0.0 | 50.4781 | 51.25907 |
| 6 | STANDARD | −67.3919 | 8.321661 | | 51.25907 | 51.25907 |
| 7 | STANDARD | 56.37384 | 15.25328 | 2.502148, 0.0 | 34.25764 | 34.25764 |
| 8 | EVENASPH | 30.24349 | 8.542505 | | 22.63562 | 34.25764 |
| STO | STANDARD | Infinity | 0 | | 15.27008 | 15.27008 |
| IMA | STANDARD | Infinity | 15.27008 | | 15.27008 | 15.27008 |

In Table 2 above, the Surface 1 Evenasph is defined as:
Coefficient on r\hat{ }2: 0
Coefficient on r\hat{ }4: −8.7389435e-06
Coefficient on r\hat{ }6: −6.0973081e-09
Coefficient on r\hat{ }8: −2.6217924e-11
Coefficient on r\hat{ }10: 0
Coefficient on r\hat{ }12: 0
Coefficient on r\hat{ }14: 0
Coefficient on r\hat{ }16: 0

In Table 2 above, the Surface 3 Evenasph is defined as:
Coefficient on r\hat{ }2: 0
Coefficient on r\hat{ }4: −1.4101947e-06
Coefficient on r\hat{ }6: −1.0897017e-10
Coefficient on r\hat{ }8: −1.4639799e-12
Coefficient on r\hat{ }10: 0
Coefficient on r\hat{ }12: 0
Coefficient on r\hat{ }14: 0
Coefficient on r\hat{ }16: 0

In Table 2 above, the Surface 8 Evenasph is defined as:
Coefficient on r\hat{ }2: 0
Coefficient on r\hat{ }4: 9.4299326e-07
Coefficient on r\hat{ }6: 2.228552e-09
Coefficient on r\hat{ }8: 5.3015707e-12
Coefficient on r\hat{ }10: 0
Coefficient on r\hat{ }12: 0
Coefficient on r\hat{ }14: 0
Coefficient on r\hat{ }16: 0

FIG. 8B illustrates a graph 810 of RMS wavefront error with respect to a field of the folded 4F ZnSe lens layout 800 of FIG. 8A, according to one embodiment. The aberrations over the field as a whole are somewhat greater, but largely still less than 1/10 wavelength. Unlike the design of FIG. 7A, which was largely limited by astigmatism and field curvature, the folded 4F ZnSe lens layout 800 balances coma, field curvature, and astigmatism to keep the RMS wavefront error within the target value. In some applications, it may be more desirable to design the optical system to have less error in the center of the field and tolerate greater error at the extremities. An optical system may perform multiple convolutions simultaneously by placing multiple functions to be convolved in the object plane, and the precision of these convolutions could be prioritized depending on their location in the object plane.

FIG. 8C illustrates a spot diagram 820 of various field points of the folded 4F ZnSe lens layout 800 of FIG. 8A, according to one embodiment. The RMS radius is confined to the Airy radius up to 6.5 mm field size for which the usable space bandwidth product is 26 million. Above this radius, the aberrations increase somewhat beyond an Airy disc. However, this amount of aberration may not be a problem for some operations, such as MaxPool, since the aberrations change slowly over the image field. Aberrations may decrease the actual maximum value in a region, however, the sample for which the value is maximized is likely to remain the same.

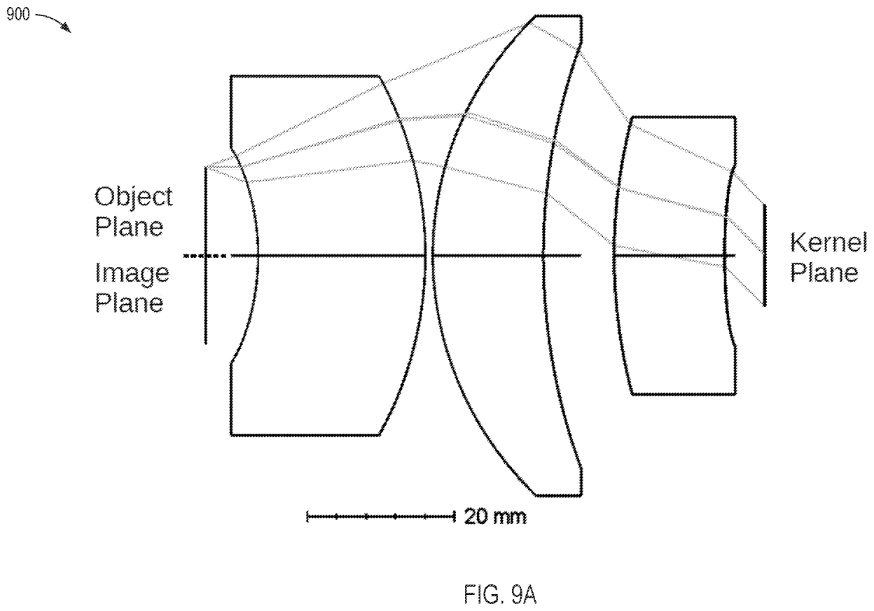

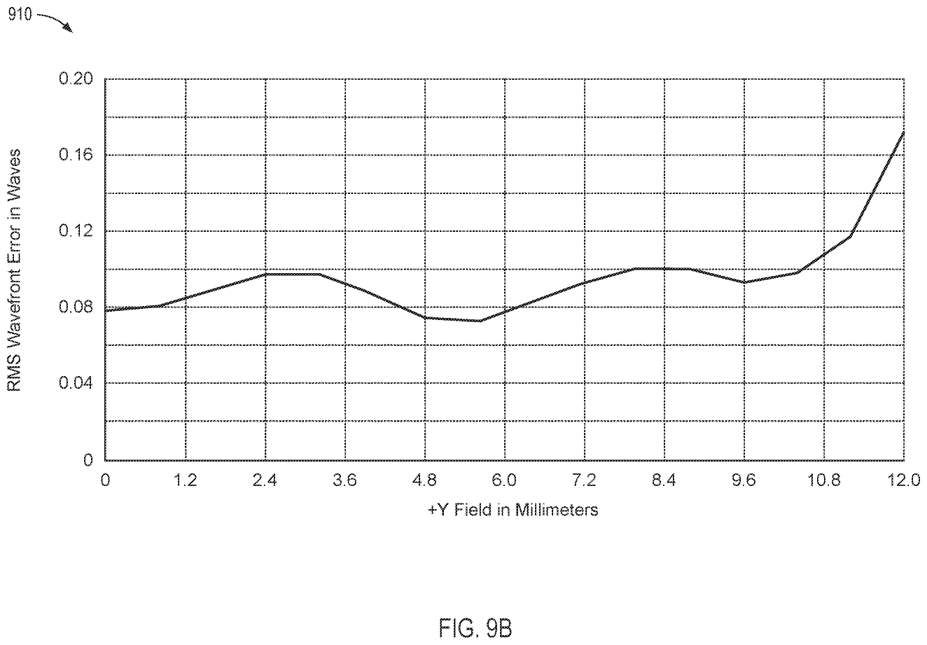

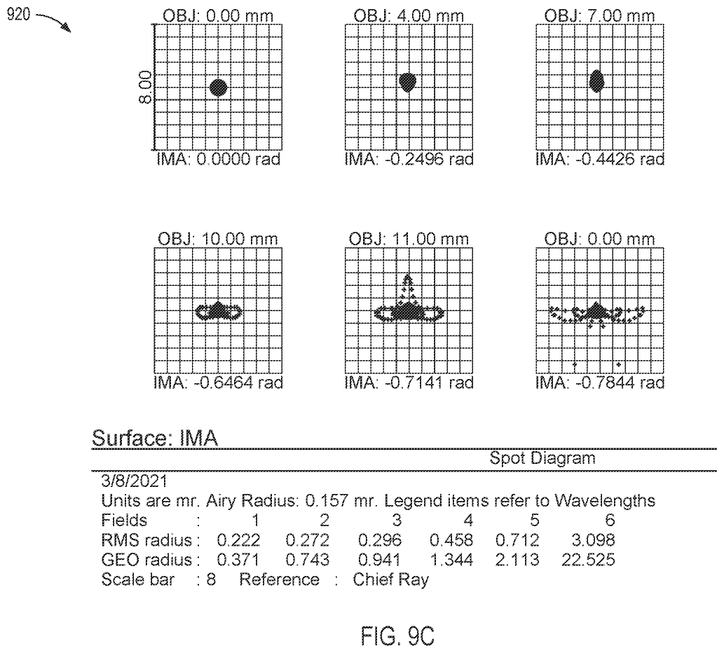

FIG. 9A illustrates an example layout 900 of a folded 4F silicon lens, according to one embodiment. The object/image field is a circle of radius 12 mm, the design wavelength is 1500 nm, and the NA is 0.35, for a SBP of 50 million. The folded 4F silicon lens 900 is an aggressive design with strong refraction at surfaces, high curvatures, and tight tolerances. This design seeks to achieve the most compact form for the given SBP. A very high refractive index of silicon at 1500 nm wavelength is partially what enables only three elements to be used in such a compact space. A diffractive element, with its very high effective refraction, can be used as well, with the limitation that undesired diffraction orders may cause an unwanted background signal to the convolution result.

The folded 4F silicon lens layout 900 is specified, including the coefficients of aspheric polynomial surfaces as follows:
Surfaces: 8
Stop: 7
System Aperture: Object Space NA=0.35
Clear Semi Diameter Margin: Millimeters=1
Fast Semi-Diameters: On
Telecentric Object Space: On
Afocal Image Space: On
Field Unpolarized: On
Convert thin film phase to ray equivalent: On
J/E Conversion Method: X Axis Reference
Glass Catalogs: SCHOTT OHARA INFRARED
Ray Aiming: Off
Apodization: Uniform, factor=0.00000E+00
Reference OPD: Exit Pupil
Paraxial Rays Setting: Ignore Coordinate Breaks
Method to Compute F/#: Tracing Rays
Method to Compute Huygens Integral: Force Planar
Print Coordinate Breaks: On
Multi-Threading: On
OPD Modulo 2 Pi: Off
Temperature (C): 2.00000E+01
Pressure (ATM): 1.00000E+00
Adjust Index Data To Environment: Off
Effective Focal Length: 16.11448 (in air at system temperature and pressure)
Effective Focal Length: 16.11448 (in image space)
Back Focal Length: 5.613171
Total Track: 68.76906
Image Space F/#: 2.156462e-09
Paraxial Working F/#: 1248.561
Working F/#: 1171.926
Image Space NA: 0.0004004609
Object Space NA: 0.35
Stop Radius: 6.020817
Paraxial Image Height: 11196.07
Paraxial Magnification: 933.0058
Entrance Pupil Diameter: 7.472647e+09
Entrance Pupil Position: 1e+10
Exit Pupil Diameter: 12.04178
Exit Pupil Diameter-X: 12.04178
Exit Pupil Diameter-Y: 12.04178
Exit Pupil Position: 0.1853327
Field Type: Object height in Millimeters
Maximum Radial Field: 12
Primary Wavelength [\hat{ }A,tm]: 1.545
Angular Magnification: 6.205599e+08
Lens Units: Millimeters
Source Units: Watts
Analysis Units: Watts/cm\hat{ }2
Afocal Mode Units: milliradians
MTF Units: cycles/millimeter

The surface data summary of the folded 4F silicon lens layout 900 is specified in Table 3 below:

TABLE 3

| | | | | | Clear | Mechanical |
|---|---|---|---|---|---|---|
| Surface | Type | Radius | Thickness | Glass | Diameter | Diameter |
| OBJ | STANDARD | Infinity | 7.102939 | | 24 | 24 |
| 1 | EVENASPH | −33.1372 | 22.72409 | Silicon | 29.04852 | 48.72152 |
| 2 | STANDARD | −50.2726 | 1 | | 48.72152 | 48.72152 |
| 3 | EVENASPH | 43.80311 | 15 | Silicon | 65.15691 | 65.15691 |
| 4 | STANDARD | 83.78752 | 9.617138 | | 57.72546 | 65.15691 |
| 5 | STANDARD | 73.09462 | 15 | Silicon | 37.6138 | 37.6138 |
| 6 | EVENASPH | 89.64182 | 5.427838 | | 24.71939 | 37.6138 |
| STO | STANDARD | Infinity | 0 | | 13.83187 | 13.83187 |
| IMA | STANDARD | Infinity | 13.83187 | | 13.83187 | 13.83187 |

In Table 3 above, the Surface 1 Evenasph is defined as:
Coefficient on r\hat{ }2: 0
Coefficient on r\hat{ }4: 4.3161812e-07
Coefficient on r\hat{ }6: 1.1218309e-08
Coefficient on r\hat{ }8: −4.0313047e-10
Coefficient on r\hat{ }10: 2.2423841e-12
Coefficient on r\hat{ }12: −6.1121826e-15
Coefficient on r\hat{ }14: 0
Coefficient on r\hat{ }16: 0

In Table 3 above, the Surface 3 Evenasph is defined as:
Coefficient on r\hat{ }2: 0
Coefficient on r\hat{ }4: −6.2882377e-07
Coefficient on r\hat{ }6: 8.8821598e-10
Coefficient on r\hat{ }8: −8.8816876e-13
Coefficient on r\hat{ }10: 3.860698e-16
Coefficient on r\hat{ }12: −1.2780631e-19
Coefficient on r\hat{ }14: 0
Coefficient on r\hat{ }16: 0

In Table 3 above, the Surface 6 Evenasph is defined as:
Coefficient on r\hat{ }2: 0
Coefficient on r\hat{ }4: 1.2896407e-05
Coefficient on r\hat{ }6: −2.4932753e-08
Coefficient on r\hat{ }8: 1.3102945e-09
Coefficient on r\hat{ }10: −1.0524062e-11
Coefficient on r\hat{ }12: 4.1700541e-14
Coefficient on r\hat{ }14: 0
Coefficient on r\hat{ }16: 0

FIG. 9B illustrates a graph 910 of RMS wavefront error with respect to a field of the folded 4F silicon lens layout 900 of FIG. 9A, according to one embodiment. The wavefront error is maintained under 1/10 wave for most of the field by balancing lower and higher orders of aberration throughout the field.

FIG. 9C illustrates spot diagram 910 of various field points of the folded 4F silicon lens layout 900 of FIG. 9A, according to one embodiment. As illustrated, the balanced lower and higher order aberration is at the expense of locality of the spectrum of the field at the kernel. As can be seen, the spot diagram 910 shows that an angular spread is significantly greater than that predicted by an Airy disc. As a result, each point in the object/image plane maps to a wide spread of frequencies in a kernel plane.

In the above examples, a Fourier transform lens reduces or minimizes the RMS wavefront error, which is intended to minimize an absolute error in computation of the Fourier transform. However, in some embodiments, it is desirable to minimize an angular spot radius instead. When the angular spot radius is minimized, a corresponding angular spectrum of each object/image point in the kernel plane is minimized. When acted on by spatial frequencies of a kernel plane SLM, the angular spectrum is only broadened by the kernel bandwidth. Once the image is formed by passing back through the Fourier transform lens, a locality of a point is preserved, and possibly broadened by the intended convolution kernel. For operations that select a maximum value, such as MaxPool, maintaining the locality of the signal may be more important than preserving a quantitative phase of the result.

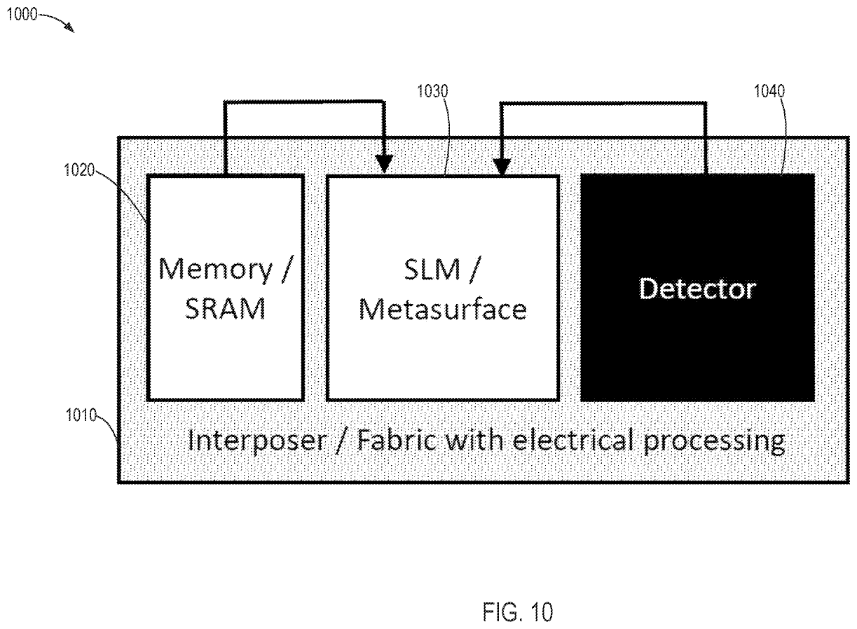

FIG. 10 illustrates a block diagram of an example optoelectronic convolution system 1000, according to one embodiment. As described herein, the optical convolution system 1000 may include zero, one, or multiple of the following elements: a Fourier transform lens, an SLM, a metasurface, an array detector, an electronic signal processing computer, a digital memory, and components to relay or convert signals between digital and optical components, such as modulators and detectors. The optoelectronic convolution system 1000 may include a lens to compute the Fourier transform on an optical field between two planes. Each “lens” may be a single thin lens with the two planes being one focal length apart on either side of the lens. However, as described above, for improved corrections of optical aberrations over a wider optical field in the image, object, or kernel planes, a compound lens system may be used, such as one of the folded 4F optical systems described above, that performs the Fourier transform operation between two planes.

According to various embodiments, an SLM may be used at each plane, a first SLM to encode data onto the optical field and a second SLM as part of an array detector to record the intensity of the optical field. As described herein, the SLM may be illuminated with a coherent light beam to be modulated. The optical field at the detector typically is superimposed with a reference beam to facilitate an interferometric reconstruction of the optical field from its intensity. In each plane of the Fourier transform lens, the SLM and array detector are advantageously placed adjacent to each other so that the recorded signal from the detector may be transferred to the SLM over a minimum distance which reduces energy consumption and delay. As illustrated, the optoelectronic convolution system 1000 includes an interposer 1010, or other fabric with electrical processing capabilities. The interposer 1010 connects a memory 1020, SLM or metasurface 1030, and an array detector 1040.

By placing the components in close proximity, interconnection distances are minimized. Reducing the distances reduces the amount of energy and decreases the delay needed to transfer data to the SLM 1030 from the array detector 1040 or the memory 1020. The interposer 1010 may also contain electronic signal processing or computation to modify the data being moved, for example, to add a carrier or to apply nonlinear operations such as ReLu or MaxPool, or to extract data to be moved off the interposer 1010 into other storage.

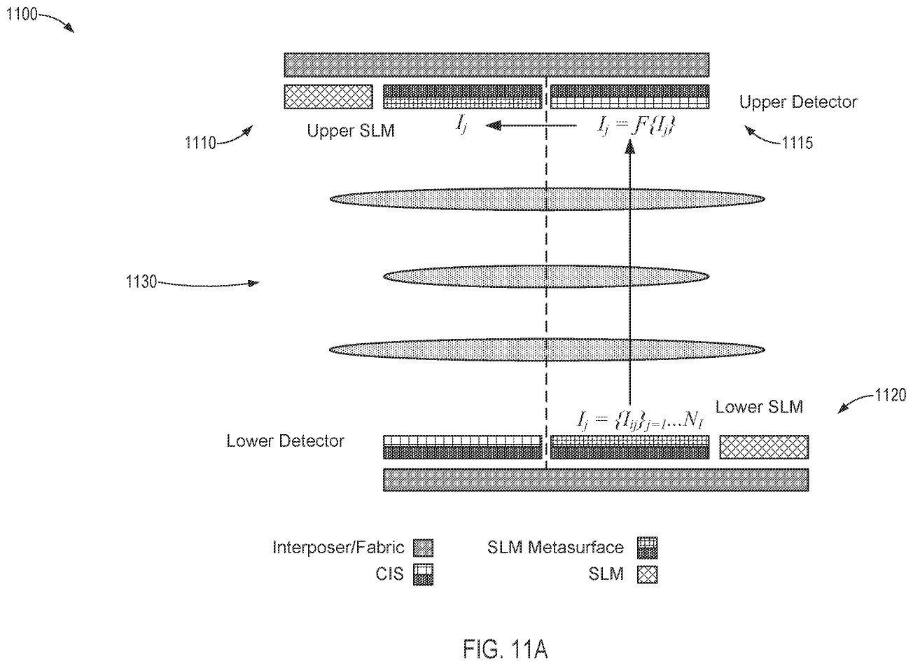

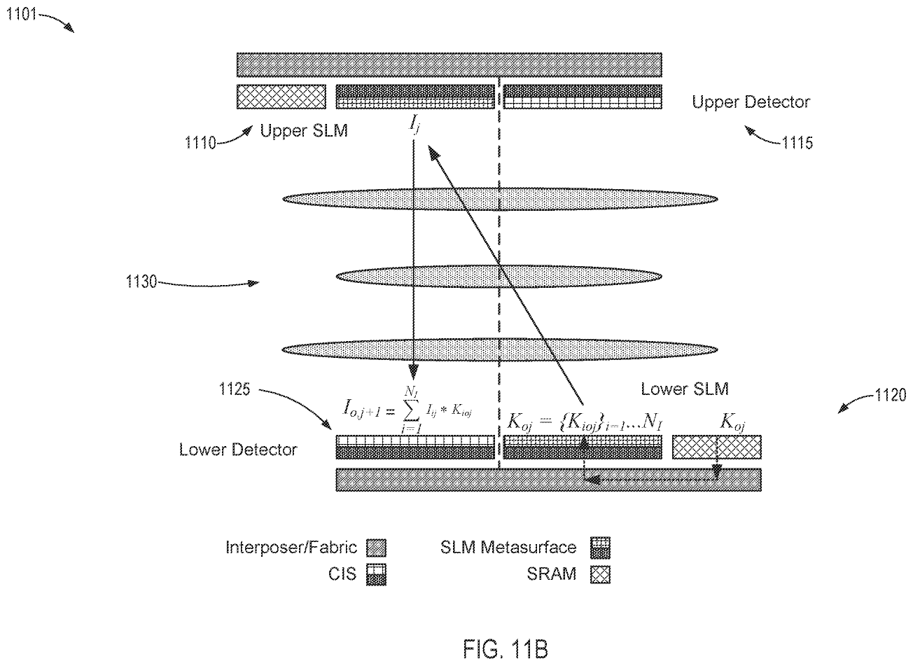

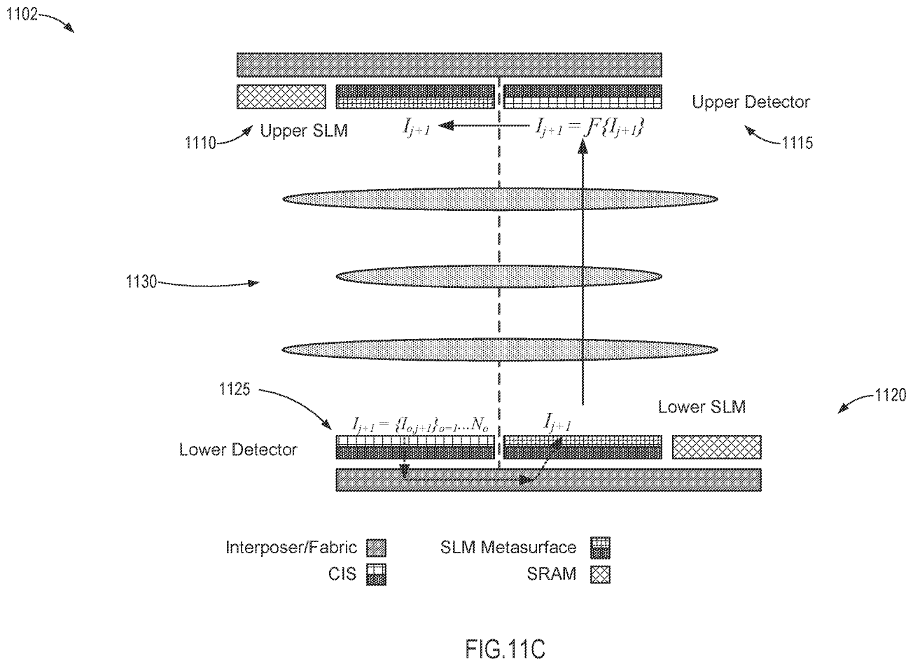

FIGS. 11A-11C illustrate stages to convolve an input function with one or more kernel functions. In each of the embodiments, the SLMs may be alternatively implemented as a metasurface. FIG. 11A illustrates a block diagram 1100 of a Fourier transform encoding stage of a convolution function via an optical convolution system with dual SLMs 1110 and 1120, according to one embodiment. As illustrated, the lower SLM 1120 encodes an input function onto incident coherent radiation. Each of the upper SLM 1110 and the lower SLM 1020 include corresponding SLM surfaces, detectors, and memory and represent an example of the interposer described in conjunction with FIG. 10. The radiation encoded by the lower SLM 1120 is conducted through a Fourier transform lens 1130 (illustrated as a three-element compound lens) to an upper detector 1115. The intensity of the Fourier-transformed field superimposed with a reference beam is detected interferometrically. This intensity pattern is then transferred to the adjacent upper SLM 1110, so that the upper SLM 1110 can encode the Fourier transform of the input function onto a field incident on it. In the process of transfer, a spatial frequency may be imposed onto the upper SLM 1110 to change the direction in which incident radiation diffracts after scattering from the upper SLM 1110.

FIG. 11B illustrates a block diagram 1101 of a kernel function encoding stage of a convolution function via a dual-SLM optical convolution system, according to one embodiment. As previously noted, the lower SLM 1120 encodes a kernel function onto incident coherent radiation. The radiation encoded by the lower SLM 1120 is conducted through the Fourier transform lens 1130 to the upper SLM 1115 so that the Fourier transform of the kernel function is formed onto the upper SLM 1115. A spatial frequency superimposed on the bottom SLM 1120 directs the radiation to the upper SLM 1110. At the upper SLM 1110, the Fourier transform of the image function that was placed onto the lower SLM 1120 (e.g., in FIG. 11A) is modulated onto the Fourier transform of the kernel function. The modulated signal is then directed to a lower detector 1125. The resulting convolution of the input and kernel is detected by the lower detector 1125 as the Fourier transform of the product of the respective Fourier transforms of the input and kernel functions. The signal may be detected interferometrically by interference with a reference beam and electronically decoded into sampled information.

FIG. 11C illustrates a block diagram 1102 of an electronic computation and relay stage of a convolution function via the dual-SLM optical convolution system, according to one embodiment. As illustrated, after the optical computations, digital electronic components may perform electronic computations to the recorded result, such as ReLu and MaxPool. In some embodiments, the results may be relayed to the lower SLM 1120 to be used for the next convolutional computation. Accordingly, to implement a successive layer of a convolutional neural network, the resulting convolution may have a ReLu, MaxPool, or other nonlinear operations applied to the data while it is in an electronically sampled (i.e., digital) form.

A further advantageous variation of the embodiments described herein is to implement compute-in-memory methods which minimize the amount of data transferred to and from a Fourier transform computation system. As described above, the Fourier transform of the input function is placed on the upper SLM 1110. The Fourier transform of the input function is convolved with a kernel function, which has its Fourier transform optically computed, and the convolution recorded on the lower detector 1125. The upper SLM 1110 serves as a memory for input data so that multiple convolutions can be performed on the same input data. The process may be repeated with many kernels, each being prepared on the lower SLM 1120 with the resulting convolution detected on the lower detector 1125. The repeated retrieval of the input function is avoided as the upper SLM 1110 retains the input function for many convolutions. As convolution is commutative with respect to the input and kernel functions, the input and kernel functions may be exchanged, and for example, the same kernel may be convolved with many input functions by placing the Fourier transform of the kernel on the upper SLM 1110.

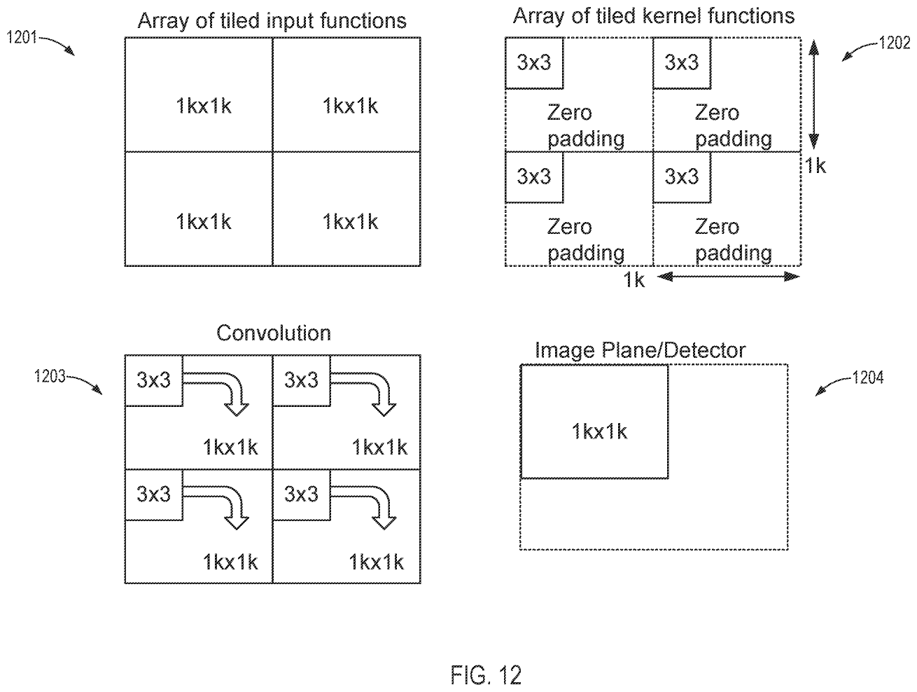

FIG. 12 illustrates multiple convolution operations performed simultaneously and added together using a single optical convolution, according to one embodiment. According to various embodiments, the optoelectronic computing system is used to simultaneously convolve several respective functions with respective kernels and add the results of the convolutions together. As illustrated, a large sampled function is tiled with several smaller sampled functions arranged periodically with zeroes padded in between the input functions such that the input functions are all uniformly spaced in the array. In this example, at 1201, a larger 2000 by 2000 sampled function is tiled with four 1000 by 1000 sampled functions.

If any of the constituent functions were smaller than 1000 by 1000 samples, zero padding is added so that the function fills its respective block of the larger function. A second large sampled function contains kernels that are uniformly and equally spaced with an identical periodicity to the first large sampled function, with the position of each respective kernel function in the second array corresponding to that of the input function in the first array. Again, the kernels are zero padded as to fill the space in between the kernels. The array of tiled input functions and the array of tiled kernel functions is convolved using the optical convolution system.

The overall convolution of the two arrays produces the sum of the convolutions of the individual input functions and their respective kernels at the position in the convolution corresponding to zero shift between the input and kernel fields, which is shown in the array of tiled kernel functions 1202 in the figure in the upper left of the convolution function, but in general depends on the origin of the optical axis of the Fourier transforms relative to the SLMs and detectors. The convolution, at 1203, of the array of tiled input functions with the array of tiled kernel functions is detected, at 1204, at the image plane by a detector.

Many existing computing systems, methods, and devices may be used in combination with the presently described systems and methods. Some of the infrastructure that can be used with embodiments disclosed herein is already available, such as general-purpose computers, computer programming tools and techniques, digital storage media, and communication links. A computing device or controller may include a processor, such as a microprocessor, a microcontroller, logic circuitry, or the like. Various technologies, systems, architectures, and applications are relevant to the presently described embodiments. Examples of such technologies, systems, architectures, and applications include, but are not limited to, certain aspects of deep neural networks, image recognition, recommender systems, medical diagnosis, language processing, and the like.

A processor may include a special-purpose processing device, such as application-specific integrated circuits (ASIC), programmable array logic (PAL), programmable logic array (PLA), programmable logic device (PLD), field programmable gate array (FPGA), or other customizable and/or programmable device. The computing device may also include a machine-readable storage device, such as non-volatile memory, static RAM, dynamic RAM, ROM, CD-ROM, disk, tape, magnetic, optical, flash memory, or other machine-readable storage medium. Various aspects of certain embodiments may be implemented using hardware, software, firmware, or a combination thereof.

The components of the disclosed embodiments, as generally described and illustrated in the figures herein, could be arranged and designed in a wide variety of different configurations. Furthermore, the features, structures, and operations associated with one embodiment may be applicable to or combined with the features, structures, or operations described in conjunction with another embodiment. In many instances, well-known structures, materials, or operations are not shown or described in detail to avoid obscuring aspects of this disclosure.

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

What is claimed is:

1. An optoelectronic computing system, comprising:
an electronic input subsystem to receive input digital data;
a first spatial light modulator to transmit a coherent optical field encoded with the input digital data;
an optical subsystem to:
implement a first Fourier transform of the coherent optical field encoded with the input digital data,
modulate kernel data onto the coherent optical field encoded with the input digital data, and
implement a second Fourier transform of the coherent optical field encoded with digital data and modulated with the kernel data to generate an output optical field encoded with a convolution of the input digital data and the kernel data;
an optical detection subsystem to convert the output optical field to an output digital signal representing the convolution of the input digital signal with the kernel data; and
a digital processing subsystem to perform at least one mathematical operation on the output digital signal.

2. The optoelectronic computing system of claim 1, wherein the first spatial light modulator comprises a first tunable optical metasurface.

3. The optoelectronic computing system of claim 2, wherein the optical subsystem includes a second spatial light modulator to modulate the kernel data onto the coherent optical field encoded with the input digital data.

4. The optoelectronic computing system of claim 3, wherein the second spatial light modulator comprises a second tunable optical metasurface.

5. The optoelectronic computing system of claim 1, wherein the optical subsystem includes a first lens assembly to implement the first Fourier transform of the coherent optical field encoded with the input digital data.

6. The optoelectronic computing system of claim 5, wherein the optical subsystem includes a second lens assembly to implement the second Fourier transform of the coherent optical field to generate the output optical field encoded with the convolution of the input digital data and the kernel data.

7. The optoelectronic computing system of claim 1, wherein the optical subsystem includes a first lens assembly to implement the first Fourier transform of the coherent optical field encoded with the input digital data;
wherein the optical subsystem includes a second, reflective spatial light modulator to:
modulate the kernel data onto the coherent optical field encoded with the input digital data, and
reflect the coherent optical field encoded with digital data and modulated with the kernel data back toward the first lens assembly; and
wherein the first lens assembly implements the second Fourier transform of the coherent optical field to generate the output optical field encoded with the convolution of the input digital data and the kernel data.

8. The optoelectronic computing system of claim 7, wherein the first lens assembly comprises seven spherical lens elements of optical glass.

9. The optoelectronic computing system of claim 7, wherein the first lens assembly comprises four aspheric lens elements of zinc selenide (ZnSe).

10. The optoelectronic computing system of claim 7, wherein the first lens assembly comprises three aspheric lens elements of silicon.

11. The optoelectronic computing system of claim 10, wherein the first spatial light modulator comprises a first tunable optical metasurface.

12. The optoelectronic computing system of claim 11, wherein the second, reflective spatial light modulator comprises a second tunable optical metasurface.

13. An optoelectronic convolutional neural network (CNN) computing system, comprising:
a first tunable optical metasurface to encode input data in the optical domain;
a second tunable metasurface to encode kernel data in the optical domain;
an optical subsystem to optically compute a convolution of the input data and the kernel data in the optical domain;
a detector subsystem to convert the computed convolution in the optical domain into a digital signal; and
a digital electronic subsystem to store the computed convolution in a digital memory.

14. The optoelectronic CNN computing system of claim 13, wherein the optical subsystem comprises a folded four-focal (4F) length optical subsystem.

15. The optoelectronic CNN computing system of claim 14, wherein the detector subsystem comprises a third tunable metasurface.

16. A system to perform convolution operations in the optical domain, comprising:
an object plane modulator to encode data onto an optical field;
a kernel plane modulator to modulate a convolution kernel onto the data-encoded optical field;
a detector to convert data-encoded optical fields into digital electrical signals; and
a folded four-focal length (4F) optical system comprising a lens assembly with a plurality of lens elements to:
implement a first Fourier transform operation of the optical field between the object plane modulator and the kernel plane modulator, and
implement a second Fourier transform operation of the optical field between the kernel plane modulator and the detector.

17. The system of claim 16, wherein the kernel plane modulator comprises a reflective spatial light modulator.

18. The system of claim 17, wherein the reflective spatial light modulator comprises a digital micromirror device.

19. The system of claim 17, wherein the reflective spatial light modulator comprises a liquid crystal on silicon device.

20. The system of claim 19, wherein the object plane modulator and the detector are integrated into a single electrical package.

21. A method to perform a convolution operation using optical fields, comprising:
encoding, via a first modulator, input data to be convolved onto an object field;
computing, via a first Fourier transform lens assembly, a first Fourier transform of the object field to generate a Fourier transform field;
applying, via a second modulator, a kernel modulation to the Fourier transform field to generate a modulated field;
computing, via the first Fourier transform lens assembly, a second Fourier transform of the modulated field to generate a convolution field representing the convolution of the input data and kernel data; and
measuring, via a detector, the convolution field to generate digital convolution data representing the convolution of the input data and the kernel data.

22. The method of claim 21, further comprising:
implementing, via a digital electronic circuit, an electrical computation using digital convolution data to generate a digital computation.

23. The method of claim 22, further comprising:
using the first modulator, the first Fourier transform lens assembly, and the second modulator, to perform a convolution of the generated digital computation with a second kernel.

24. An optical system, comprising:
a first lens element group comprising at least one lens element that images point objects into collimated beams;
a second lens element group comprising at least one lens element that has a telecentric entrance pupil in an object space;
a third lens element group comprising at least one lens element with an afocal field in a collimated space;
a fourth lens element group comprising at least one lens element for which vignetting occurs in the collimated space; and
a fifth lens element group comprising at least one lens element that does not have a plane of symmetry over which the system of lenses reflected over the plane is unchanged.

25. The optical system of claim 24, wherein vignetting of the fourth lens element group occurs only in the collimated space.

26. The optical system of claim 24, wherein a space-bandwidth product exceeds 1,000,000, a numerical aperture is at least 0.2, and a root-mean-square wavefront error is less than 0.25 wavelengths over the afocal field.

27. The optical system of claim 26, wherein at least one lens element of the optical system is part of two different lens element groups.

28. The optical system of claim 26, wherein at least one of the first, second, third, fourth, and fifth lens element groups comprises a single lens element that is also the only lens element in another of the first, second, third, fourth, and fifth lens element groups.

29. The optical system of claim 26, wherein seven spherical lens elements of optical glass are used to form the first, second, third, fourth, and fifth lens element groups.

30. The optical system of claim 26, wherein four aspheric lens elements of zinc selenide (ZnSe) are used to form the first, second, third, fourth, and fifth lens element groups.

31. The optical system of claim 26, wherein three aspheric lens elements of silicon are used to form the first, second, third, fourth, and fifth lens element groups.
